(19) United States
(12) Patent Application Publication
(10) Pub. No.: US 2014/0184615 A1
(43) Pub. Date: Jul. 3, 2014

(54) Sequential Rendering For Field-Sequential Color Displays

(71) Applicant: NOKIA CORPORATION, Espoo (FI)

(72) Inventor: Johan Bergquist, Tokyo (JP)

(73) Assignee: Nokia Corporation, Espoo (FI)

(21) Appl. No.: 13/729,909

(22) Filed: Dec. 28, 2012

(51) Int. Cl. G06T 1/60

(52) U.S. Cl. CPC G06T 1/60
USPC 345/503; 345/549; 345/520

(57) ABSTRACT

The specification and drawings present a new method, apparatus and software related product (e.g., a computer readable memory) for sequential rendering (including hardware acceleration) each primary color of a plurality of primary colors in each frame of an image separately in a space-time domain for displaying on field-sequential color (FSC) displays. Instead of rendering whole pixels, various embodiments provide rendering of each primary color plane separately in the space-time domain, and serializing/sequencing the colors of the the rendered data directly to the bus that is connecting a host (an operator device) and the FSC display. Generally the number of primary colors may be two or more. When displayed on a FSC display, motion quality may be largely improved.

### TECHNICAL FIELD

The exemplary and non-limiting embodiments of this invention relate generally to electronic displays and more specifically to sequential rendering for field-sequential color displays.

### BACKGROUND ART

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section.

Kinetic UIs, such as map browsing and scrolling of web pages and lists, require good motion quality in order to make the text legible. Current displays do not provide that. In augmented reality, a large temporal aperture in the camera-display pipeline results in motion blur so that a picture doesn't look real on the viewfinder display. Motion quality is limited by the data bandwidth of the graphics hardware accelerator (HWA) and graphics processing unit (GPU) rendering, respectively, but also by the temporal aperture of the display. Most displays are limiting the temporal aperture of the rendering pipeline to about 1/60s, which causes a motion blur, even if the shutter time of the camera is short and/or sampling rate is high

### SUMMARY

According to a first embodiment of the invention, a method comprising: rendering, by an operating module of an apparatus, each primary color of a plurality of primary colors in each frame of an image separately in a space-time domain; and writing data indicative of the rendered image in a buffer memory by the operating module.

According to a second embodiment of the invention, an apparatus comprising: at least one processor and a memory storing a set of computer instructions, in which the processor and the memory storing the computer instructions are configured to cause the apparatus to: render each primary color of a plurality of primary colors in each frame of an image separately in a space-time domain; and write data indicative of the rendered image in a buffer memory by the operating module.

According to a third embodiment of the invention, a computer program product comprising a non-transitory computer readable medium bearing computer program code embodied herein for use with a computer, the computer program code comprising: code for rendering each primary color of a plurality of primary colors in each frame of an image separately in a space-time domain; and code for writing data indicative of the rendered image in a buffer memory.

### BRIEF DESCRIPTION OF THE DRAWINGS:

For a better understanding of the nature and objects of the present invention, reference is made to the following detailed description taken in conjunction with the following drawings, in which:

FIG. 1 is a timing diagram of rendering, read-out, and serialization of a conventional GPU, HWA, or graphics subsystem.

FIG. 2 is a timing diagram of rendering and read-out for three primary colors red green and blue, according to an exemplary embodiment described herein;

FIGS. 3a-3b are images of a moving white box in the space-time coordinates for a conventional display (FIG. 3a), for a color-sequentially rendered FSC display (FIG. 3b) according to an exemplary embodiment described herein, and for a conventionally rendered FSC display (FIG. 3c);

FIGS. 4a-4b are time-space diagrams for a conventional camera (FIG. 4a) and for a color-sequential sampling camera (FIG. 4b) according to an exemplary embodiment described herein;

FIGS. 5a-5b are schematic diagrams for demonstrating color-sequential sampling, using color-sequential illumination in a monochrome camera shown in FIG. 5b according to an exemplary embodiment described herein, whereas FIG. 5a shows a conventional camera illumination for non-sequential sampling;

FIG. 6 is a block diagram for providing of a sequentially rendered content, according to exemplary embodiments described herein;

FIG. 7 is a flow chart demonstrating implementation of exemplary embodiments of the invetion; and

FIG. 8 is a block diagram of an electronic device for practicing exemplary embodiments described herein.

### DETAILED DESCRIPTION

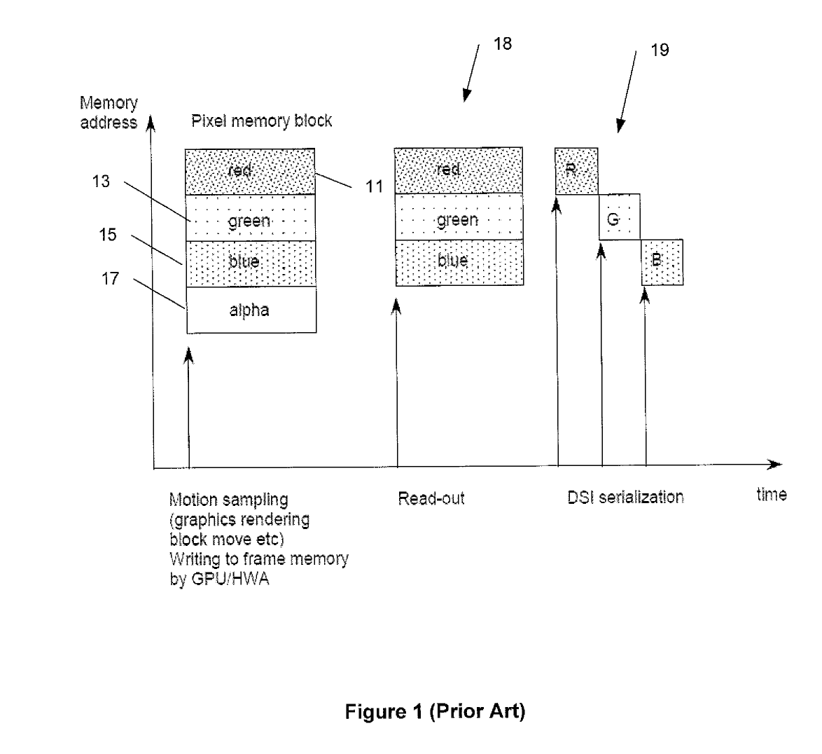

By way of introduction, a high motion quality in displays is usually accomplished by high rendering/refresh rate, and/or short frame duty. This requires a graphics processing unit (GPU) and/or hardware accelerator (HWA) capable of rendering whole pixels (e.g. RGB simultaneously) at high speed, as shown in FIG. 1 and further discussed herein.

Another approach, often used in LCD TVs, is a frame interpolation. Original content is captured by the TV camera rendered/encoded in YCC color space at 60 Hz. In the TV, it is converted to RGB, a motion is estimated, either in RGB or YCC space, and one or several inserted frames are synthesized based on the motion prediction. The resulting frames are then played back at a higher frame rate such that the original frames (non-synthesized) are played back at the original frame rate (e.g., 60 Hz).

Another way to achieve improved motion quality is by duty display driving (such as backlight blinking in LCDs). In that case, at least 75 Hz refresh rate is necessary to avoid flicker effect. When the rendering rate is less than the refresh rate, frame drops can occur and the motion may become jugged. Therefore, HWA/GPUs in systems with duty-driven displays need to render RGB simultaneously at least at 75 fps. For video content, the refresh rate needs to be a multiple of the camera sampling rate, e.g. 3×25 fps for PAL TV, in order to avoid frame drops and jaggedness. Even so, a motion blurring can occur from smooth pursuit eye tracking (SPET) since the eyes try to track moving objects continuously while they are rendered at quantized steps. Duty driving can be implemented by black frame insertion (BFI) instead of inserting the motion-interpolated frames.

The duty driving can also be implemented by LCD backlight blinking, or using a combination with BFI. In both cases, the drawback is lower average luminance. Therefore, the peak LED intensity may to be increased to maintain the average luminance. Consequently, the LEDs or pixels then may to be driven at higher currents which decreases luminous efficacy. In LCDs, a larger number of LEDs becomes necessary which affects cost negatively.

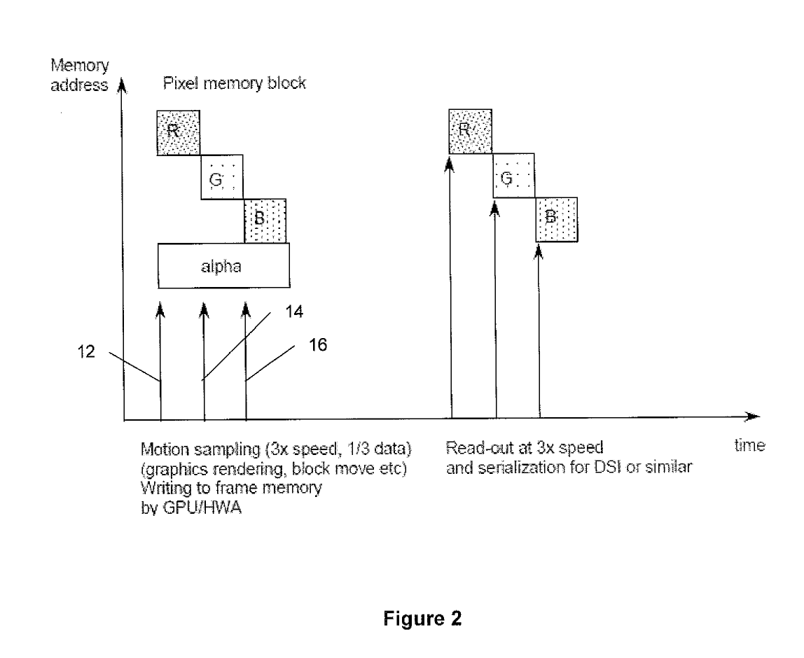

To overcome the aforementioned problems and drawbacks, a new method, apparatus, and software related product (such as a non-transitory computer readable memory) are presented for sequential rendering (including hardware acceleration) each primary color of a plurality of primary colors in each frame of an image separately in a space-time domain for displaying on field-sequential color (FSC) displays. Instead of rendering whole pixels (as shown in FIG. 1), various embodiments provide rendering of each primary color plane separately in the space-time domain (as shown in FIG. 2 and further discussed herein), and serializing/sequencing the colors of the rendered data directly to the bus that is connecting a host (an operator device) and the FSC display. It is noted that serializing is an interface issue rather than a data format issue. Conventional RGB data is serialized by interleaving the color planes, sending byte sequences like RGBRGBRG. In the embodiment described herein, instead, data may be sent as RRRRRRRRRR . . . GGGGGGGGGG . . . BBBBBBBB, so that each color plane is serialized separately without interleaving them.

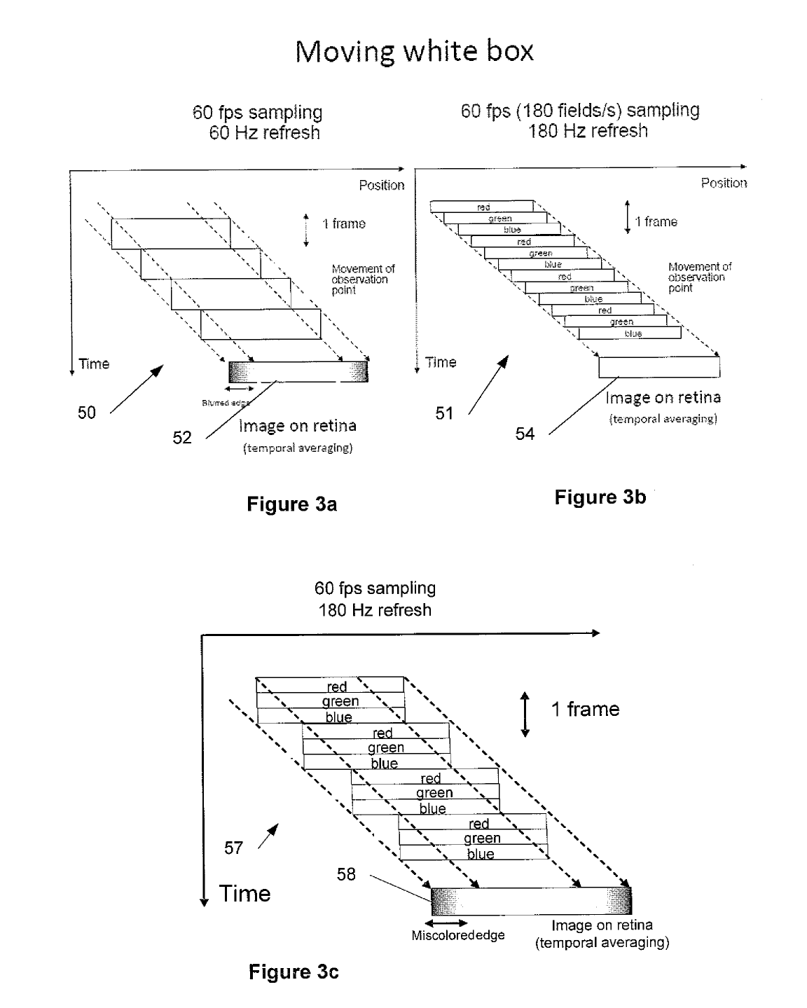

Generally the number of primary colors may be two or more (for example 3 primary colors for RGB, 3 primary colors for CMY, 4 primary colors for RGBY or RGBC, etc.). When displayed on a FSC display, motion quality may be largely improved as illustrated in FIG. 3.

For example, according to various exemplary embodiments, rendering and/or hardware acceleration of various graphics tasks may be implemented by calculating and writing image data into a frame buffer which can be located in the main system, in an intermediate buffer IC, integrated in the display driver IC, or in the display itself, if it has a memory and processing function.

In a conventional graphic system shown FIG. 1, RGB channels 11, 13 and 15, and alpha channel 17 (transparency channel) are rendered at the same time so all subpixels correspond to the same position and sample time both in the memory and on the display. Once the data is rendered, it is read (read-out 18) from the frame memory and serialized (DSI serialization 19) for transmission to the display module. This can be done in sequence with any block size but in any case, the time-space coordinate of one rendered pixel (RGB triplet) in FIG. 1 is always the same.

According to an exemplary embodiment as demonstrated in FIG. 2, the frame buffer data may be rendered/moved at a rate corresponding to the rate of unique fields in the FSC display, but the data size is only 1/N of conventional display rendering, where N is the number of primary colors. This is illustrated on the left side of FIG. 2 for RGB case indicating by arrows 12, 14 and 16 at different space-time coordinates of the rendered subpixel. Also in this case, the memory blocks could be of any size but for each sampling (rendering) time-space coordinate, they may store just a single primary color.

It is further noted that the data bandwidth for the rendered data according to the exemplary embodiments described herein is the same as in the conventional rendering while the field rate for displaying the written image data is a frame rate multiplied by a number of primary colors. For example, a 24 bpp RGB FSC display with nominally 60 fps whole-pixel rendering is rendered at a field rate of 3×60=180 fps (fields per second) but the amount of data is only 24 bit/3=8 bit. Hence the single-pixel data bandwidth is unchanged and stays the same as for a conventional 60 fps display, i.e., it equals in both cases 24×60=8×180 =1440 bps. Likewise, the display pixel data bandwidth (single-pixel bandwidth multiplied by the number of pixels) stays the same.

FIGS. 3a-3c show images of a moving white box 50, 51 and 57 in the space-time coordinates for a conventional display (FIG. 3a), for a sequentially rendered FSC display (FIG. 3b) according to an exemplary embodiment and for a conventionally rendered FSC display (FIG. 3c). The difference in edge blur between sequentially rendered FSC according to the embodiment (see FIG. 3b with no blur), and conventional displays (see FIG. 3a) and conventionally rendered FSC (FIG. 3c) for 100% duty, is also shown. It is evident from FIGS. 3a-3c that the images 52 and 58 created on retina in the conventional case (FIG. 3a) is blurred on the edges and in the conventionally rendered FSC case (FIG. 3c) the blur is manifested (replaced) by miscolored edges, whereas in the sequential rendered image 54 (FIG. 3b), the edges are neither blurred, nor miscolored. It is noted that the FSC displays have less than 100% LED field duty so the actual difference in motion quality may be even bigger than shown in FIGS. 3a-3c in favor of the sequentially rendered FSC display. It is further noted that miscoloured edges in FIG. 3c may be caused by so-called SPET color break-up (CBU). Therefore, the embodiment described herein can also solve the problem of SPET CBU in FSCs.

It should be also noted that writing into the graphics memory is not necessary for some graphics tasks. A simple but important case of graphics acceleration is scrolling where the memory pointer can be moved to another location in the memory as further discussed herein.

Various scenarios may be contemplated for using exemplary embodiments. In one example, the GPU (alone) can provide sequential rendering of vector graphics for each primary color in each frame of an image separately in a space-time domain for displaying on the FSC display by calculating and writing sequential image data into a frame buffer, where the original image/data (before calculating the sequential image data) could be stored in a conventional way as shown in FIG. 1.

In another scenario, writing into the graphics memory may not be necessary for some graphics tasks. An important case of using graphics acceleration (e.g., using HWA) may include a fast movement such as scrolling, zooming, rotation, panning (and the like) of a pre-rendered image, e.g., on a computer screen, where the memory pointer can be moved to another location in the memory using the HWA. In this case, using HWA can improve image quality and avoid image distortions/defects such as blurring and color break-up.

Moreover, in a further example, the incoming video stream (having a conventional format as shown in FIG. 1) may be decoded, filtered, and/or up-sampled to provide the sequential rendering as described herein for writing in the frame buffer and/or displaying on the FSC display (possibly in real time or near real time). It is noted that video streams of high sampling rates can be filtered in the same way as high-rate streams from the camera. For a nominal sampling rate, frame interpolation may be necessary too. Motion prediction can be done separately for each color (RGB) or in YCC and then converted into RGB or whatever color space the display has (more than 3 primaries are possible as stated herein).

In a further scenario, a camera/camera device can capture the video image at high frame rates (at least 120 fps). Then the camera may not need to encode captured data into YCC MPEG or JPEG—it can output RGB frames down-sampled from a camera resolution (typically 8 megapixels) to a display resolution (typically less than 1 megapixel) at a high frame rate. Camera bandwidth is usually 60 Hz for full resolution which means that 8*60-480 Hz sampling is possible with the display resolution and maintained pixel bandwidth. Once the frame writing is finished, the frame buffer is then posted to the display, synchronized to the display's VSYNC so there is no tearing. This means that the serializer (using frame buffer read-out function) can pick up planes from these separate colors (such as RGB) buffers in sequence for subsequent displaying (where each color plane is serialized completely and separately, not word-by-word).

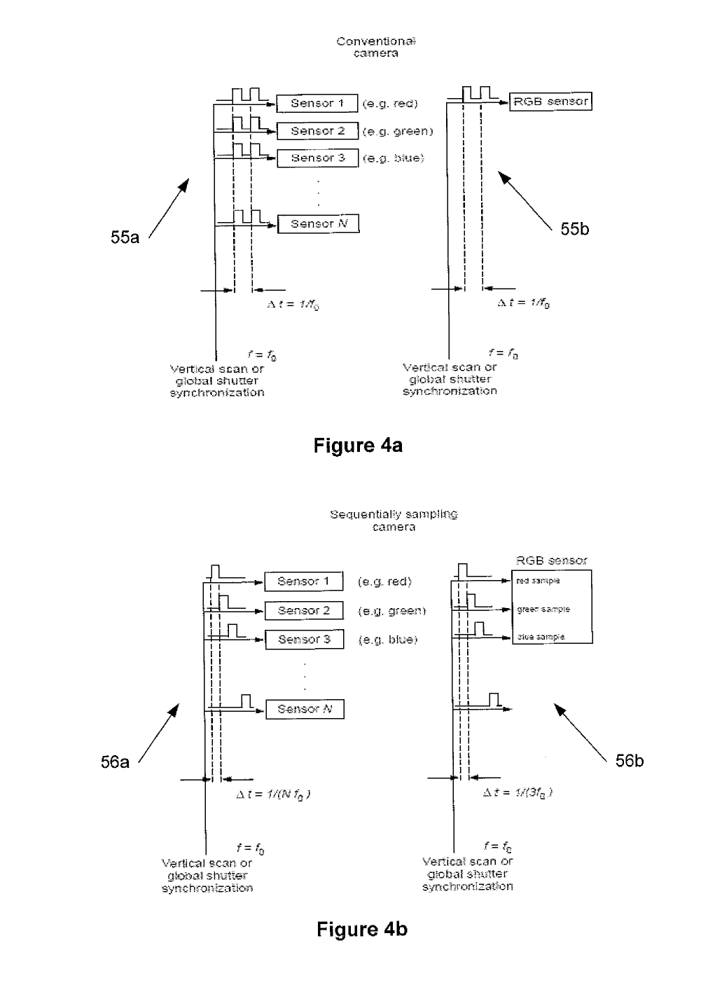

In another embodiment, color-sequential sampling/image capturing can be implemented directly in solid-state cameras comprising, for example complementary metal-oxide-semiconductor (CMOS) sensors or coupled-charged devices (CCD). The solid-state camera may be configured to sample each primary color sequentially when capturing the image, so that the primary colors are sampled/captured synchronously and sequentially. FIGS. 4a-4b show time-space (vertical scan) diagrams 55a, 55b, 56a and 56b: for a conventional camera (FIG. 4a) and for a color-sequential sampling camera (FIG. 4b) according to an exemplary embodiment of the invention. The moving images which can be captured by the solid-state cameras using color-sequential sampling would have motion quality improved by a factor of N (a number of the primary colors) at the original bandwidth. The synchronization scheme shown in FIG. 4b can be used with both rolling and global shutters.

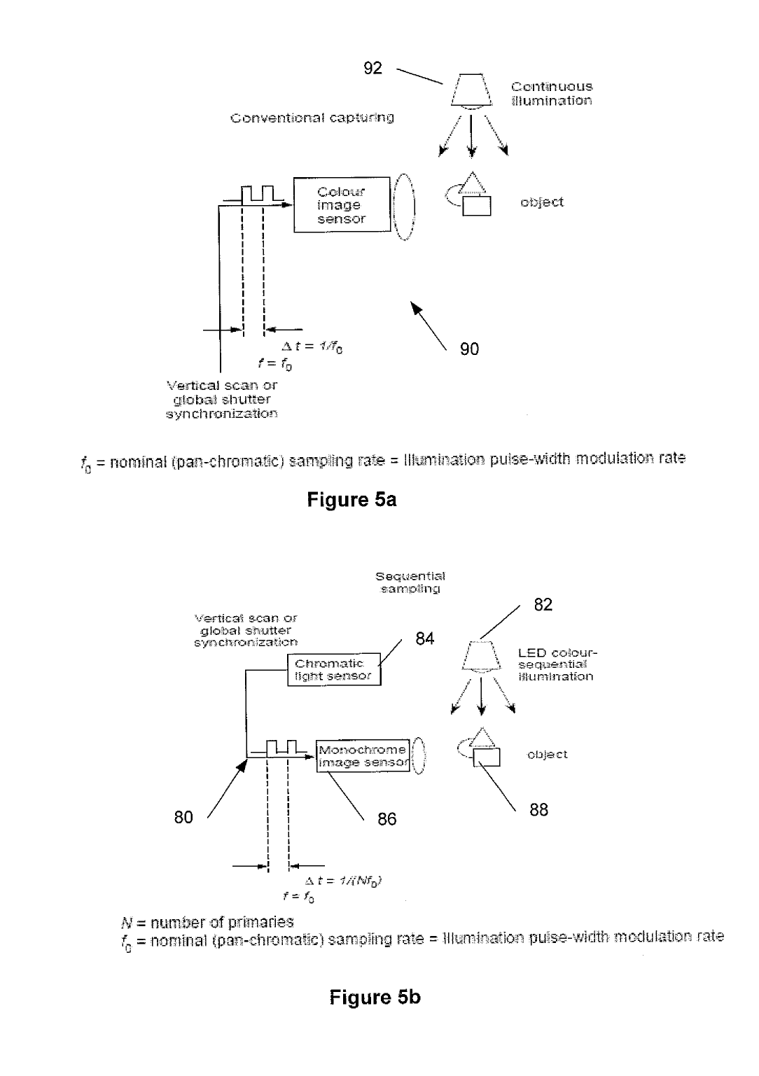

FIGS. 5a-5b show schematic diagrams for demonstrating another example for color-sequential sampling, using color-sequential illumination 82 of the object 88 for color-sequential sampling/image (using a monochrome image sensor 86 and a chromatic light sensor 84) capturing in a monochrome solid-state camera 80 shown in FIG. 5b according to an exemplary embodiment of the invention as explained herein, whereas FIG. 5a shows a conventional camera 90 with continuous illumination 92 for non-sequential sampling.

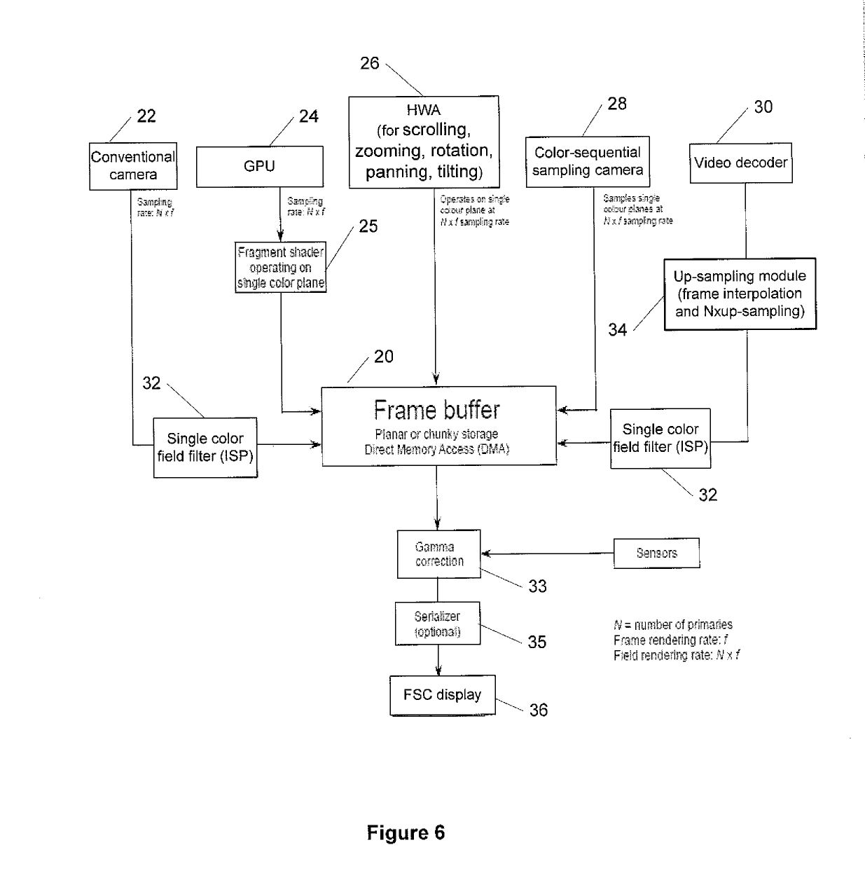

FIG. 6 shows a block diagram summarizing different options discussed herein for providing a sequentially rendered content, according to exemplary embodiments of the invention. In one option, the operating module may comprises at least a graphic processing unit (GPU) 24 configured to operate on a single color plane at a rendering rate equal to a frame rendering rate multiplied by a number of the primary colors, and a fragment shader 25 operating on the single color plane.

Moreover, the operating module may comprise at least a graphic (display) hardware accelerator (HWA) 26 configured to operate on a single color plane at a sampling rate equal to a frame rendering rate multiplied by a number of the primary colors to minimize image distortions. This can secure that a displayed image of the rendered image from the buffer memory is moved fast without distortions (e.g., fast movement may be scrolling, zooming, rotation, tilting, panning, etc.) on a display 36 by moving the pointer of data indicative of the rendered image in a buffer memory (frame buffer) 20 using the graphic hardware accelerator 26.

It is further noted that the operating module may comprise both the GPU 24 for writing the rendered image (rasterized image) in the buffer memory (frame buffer) 20 and the HWA 26 for moving the pointer of data indicative of the rendered image in the buffer memory (frame buffer) 20 and also for block move and scaling (pixel interpolation/extrapolation) operation for example for zooming/tilting.

Furthermore, the operating module may comprise at least a color-sequential sampling solid-state camera 28 (see FIG. 4b) configured to sample each primary color sequentially when capturing the image. According to one exemplary embodiment, the color-sequential sampling solid-state camera may be a monochrome camera (see FIG. 5b) configured to sample colors sequentially using sequential illumination synchronized with the camera.

According to a further embodiment described herein and shown in FIG. 6, the operating module may comprise at least a video decoder 30, an up-sampling module 34 and an ISP comprising a single color field filter 32. Also, the operating module may comprises at least a high sampling rate camera 22 (e.g., a sampling rate may be equal to a frame rendering rate multiplied by a number of the primary colors) and an image signal processor comprising a single color field filter 32.

The rendered content may be saved in the frame buffer 20 with a subsequent conventional gamma correction (module 33) and serialization (module 35, the serialization may be performed by the operating module) for displaying the image on the FSC display 36. It is noted that serialization may be optional because it's just an interface type which also could be parallel. For each color sampled at different times, data transfer could be either serial or parallel. In the case of parallel transfer, there would be a frame buffer in the display from which color planes may be read sequentially.

The frame buffer 20 can store the rendered image in several ways such as:

1-bit: monochrome,

4/8-bit palettized,

16-bit high color,

24-bit true color,

alpha: transparency.

However, the color depths indicated above are exemplary and should not limit implementations options for embodiments described herein. Also, the pixels can be stored with colors in sequence (packed pixel or chunky), or each color plane separate (planar). In palettized case, the palette can exist of any number of primaries with any depth. Spatiotemporal rendering is done at N times a nominal speed (N=number of primaries) but only one color per sampling point is read from a palette LUT.

Furthermore, the frame buffer can have page flipping, that is, simultaneous writing/reading at different memory pages, and switch between pages during a blanking period. Some graphical objects can be sequentially rendered separately and overlaid on the memory, e.g., blending of a mouse icon or an on-screen display. Also some post-rendering filtering can be done similarly, i.e., using spatial anti-aliasing. The latter doesn't affect the rendering speed but is applied globally on all pixels.

Thus, according to a further embodiment, an apparatus can comprise means for rendering each primary color of a plurality of primary colors in each frame of an image separately in a space-time domain; and means for writing, and/or moving a pointer of, data indicative of the rendered image in a buffer memory by the operating module.

Advantages of implementing embodiments may include (but not limited to) the following. 3× motion quality may be achieved at 1× display data bandwidth for an RGB (or the like) display. For more than three primaries, the motion quality may be improved even more (in proportion to N for a display with N primary colors). Sequential rendering may also reduce color break-up due to the SPET. Another advantage is that a double buffer is not necessary, otherwise common in FSC systems. This enables high-pixel count FSC displays such as FHD (fine home displays) or 2K4K displays.

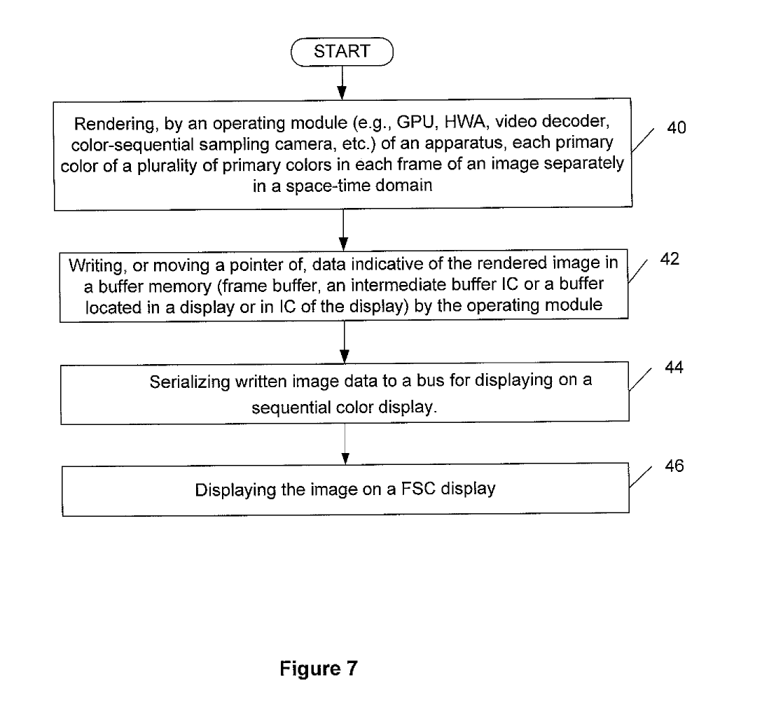

FIG. 7 shows an example of a flow chart demonstrating implementation of exemplary embodiments of the invention by an operating module of an electronic device. It is noted that the order of steps shown in FIG. 7 is not absolutely required, so in principle, the various steps may be performed out of the illustrated order. Also certain steps may be skipped or selected steps or groups of steps may be performed in a separate application.

In a method according to this exemplary embodiment, as shown in FIG. 7, in a first step 40, an operating module (GPU, HWA, video decoder, color-sequential sampling camera, etc.) of an apparatus renders each primary color of a plurality of primary colors in each frame of an image separately in a space-time domain.

In a step 42, the operating module writes image data of the rendered image into a buffer memory (e.g., frame buffer, an intermediate buffer IC or a buffer located in a display or in IC of the display). Also this step may further include moving the pointer of data indicative of the rendered image in the buffer memory for the fast image movement (such as scrolling, zooming, rotation, panning, tilting) on the display using HWA.

In a step 44, a serializer (could be an operating module such as GPU) serializes written image data to a bus for displaying on a sequential color display. In a step 46, a FSC display displays the image data using the rendered sequential image data. Parallel interface for image data transfer can be also possible as described herein.

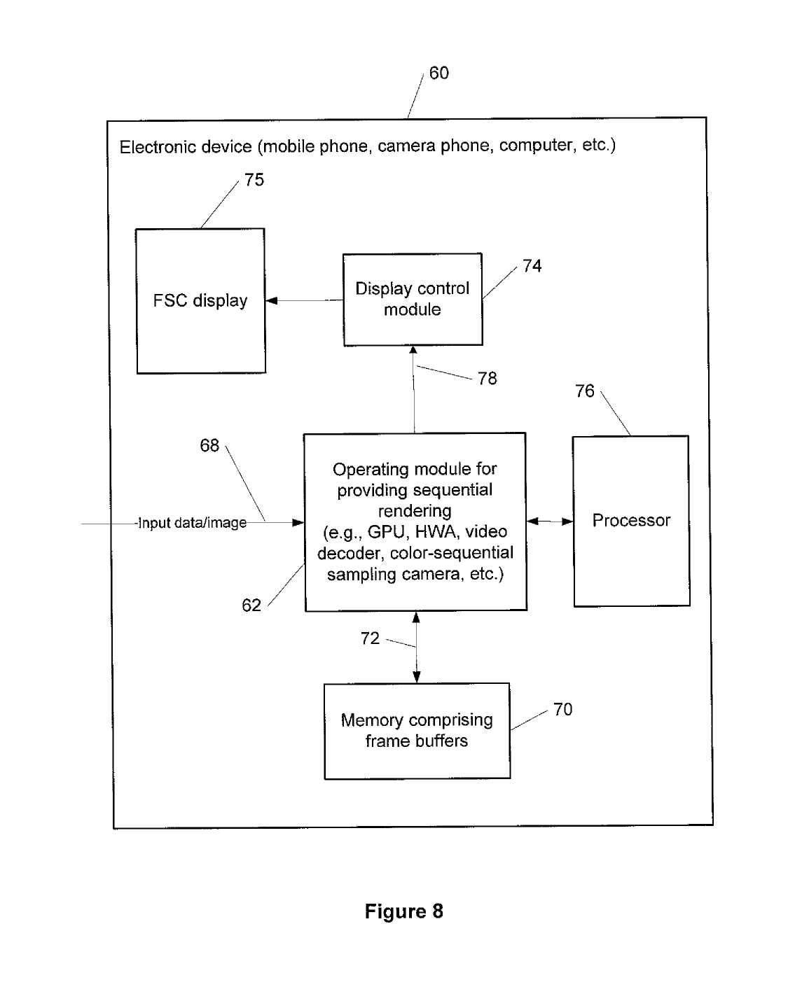

FIG. 8 shows an example of a simplified block diagram of an electronic device 60 for implementing embodiments of the invention as described herein. FIG. 8 is a simplified block diagram of the electronic device that is suitable for practicing the exemplary embodiments of this invention, e.g., in reference to FIGS. 2-7, and a specific manner in which components of an electronic device are configured to cause that electronic device 60 to operate. The electronic device 60 may be implemented as a portable or non-portable electronic device, a computer, a wireless communication device with a display, a camera phone and the like.

The device 60 comprises an operating module 62 (e.g., GPU, HWA, video decoder, color-sequential sampling camera, etc.) as described herein (e.g., see FIG. 6 for details) for implementing steps 40-44 in FIG. 7 as described herein. The module 62 may receive input data/image data via link 68 to implement step 40 of FIG. 7. The operating module 62 may use a link 72 to implement step 42 and links 72 and 78 to possibly implement step 44 shown in FIG. 7. FIG. 8 also shows FSC display 75 and a display control module 74.

The device 60 further comprises at least one memory 70 (comprising frame buffer for implementing embodiments of the invention) and at least one processor 76.

Various embodiments of the at least one memory 70 (e.g., computer readable memory) may include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the processor 76 include but are not limited to general purpose computers, special purpose computers, microprocessors, digital signal processors (DSPs) and multi-core processors.

The module 76 may be implemented as an application computer program stored in the memory 70, but in general it may be implemented as software, firmware and/or hardware module or a combination thereof. In particular, in the case of software or firmware, one embodiment may be implemented using a software related product such as a computer readable memory (e.g., non-transitory computer readable memory), computer readable medium or a computer readable storage structure comprising computer readable instructions (e.g., program instructions) using a computer program code (i.e., the software or firmware) thereon to be executed by a computer processor.

Furthermore, the module 76 may be implemented as a separate block or may be combined with any other module/block of the electronic device 60, or it may be split into several blocks according to their functionality.

It is noted that various non-limiting embodiments described herein may be used separately, combined or selectively combined for specific applications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the present invention. Numerous modifications and alternative arrangements may be devised by those skilled in the art without departing from the scope of the invention, and the appended claims are intended to cover such modifications and arrangements.

The following terms and definitions that may be found in the specification and/or the drawing figures are defined as follows:

Backlight blinking (BBL): LED flashing synchronized with the LCD refresh rate, typically with a delay to allow for the image to be written completely to the LCD, and for the liquid crystal to respond.

Black field insertion (BFT): Adds a black frame or subframe to image frames; increases motion quality via the decreased temporal aperture but luminous efficacy in BFI LCDs is reduced because backlight is absorbed during the black fields.

Color break-up (CBU): Motion artifact in field-sequential color displays caused by eye motion relative to the display and/or display content. CBU can be either saccadic or caused by SPET. Saccadic CBU occurs when the gaze point is moved quickly across the display/screen so that each color field is imaged at different locations on the retina. Therefore, color fusion does not occur and edges of high-contrast objects appeared colored. Saccadic CBU can be completely eliminated by very high refresh rates (˜2 kHz) but can be significantly reduced for lower rates by reducing display gamut, luminance, color field composition (e.g. RGBG, RGBW, CMY instead of RGB, etc.), and subfield reordering (digital grey scale such as DMD, DMS). CBU reduction by subfield reordering trades-off with dynamic false contour artifact. In direct-view mobile displays, saccadic CBU is not significant because of the small field of view, automatic dimming, and relatively bright adaptation state of the eye. SPET CBU occurs when the eyes are tracking a moving object on the display. Origin is the same as motion blur from hold-type displays (100% frame duty) and can be reduced by reducing the temporal aperture. Contrary to saccadic CBU, the edges will be colored by the complementary colors of the primaries so an RGB FSC will exhibit CMY edges. This can be completely eliminated by rendering RGBG at a frame rate equal to F/(2N-1), where F is a field refresh rate and N a positive integer.

Display duty: Ratio of optical hold time to frame period.

Dynamic false contour: SPET-based tone-rendering distortion that is visible for moving objects with shade gradients on a display with temporal (PWM, pulse width modulation of subfields) grey scale. Origin is the same as SPET CBU, for example the binary weighted grey shade values are rendered at different locations on the retina so that temporal integration is not complete, and visual bit weights erroneous.

Flicker: Perceived blinking of the display caused by a refresh rate lower than the flicker fusion frequency (FFF). Flicker sensitivity varies between individuals, field of view, luminance, contrast, and ambient light, and therefore adaptation state/pupil size. Peripheral vision is more sensitive to flicker and more visible in the dark and/or on bright displays.

Frame drop: Occurs for displays with TE synchronization where the refresh rate is a non-integer multiple of the rendering rate, results in juggedness and jitter. Can be minimized by controlled down-sampling, for example, even temporal distribution of the dropped frames.

Frame period: Reciprocal of refresh rate; for example, the frame period of a 60 Hz display is 16⅔ ms.

Ghosting: Doubled edges of objects on screen. A well-known artifact in analog television where the radio waves bounce and arrive at different times at the antenna. Ghosting in motion is caused by a mismatch between backlight blinking timing and display refresh—LED is turned on before the LCD has responded completely. Can be avoided by scanning backlight, fast LCD response, and/or short LED duty. Can also be caused by signal cross-talk

Shadowing: Similar to ghosting but dark instead of bright. Caused by signal cross-talk.

Hold time The time during which one frame is displayed.

Jitter: Special case of juggedness where the delays are random.

Judder: Edge flickering of objects caused by too low sampling/rendering rate and/or too fast camera motion/scrolling. Can be used artistically and reduced by defocusing or contrast reduction. Often visible when viewing 24 fps motion pictures on a high-contrast TV.

Juggedness: Motion rendering which appears in visible steps and not smooth. Caused by low and/or non-constant sampling rate as well as by frame drops.

Light break-up (LBU): Special case of saccadic CBU where the light source is monochrome. Can be seen in PWM-modulated rear lights of cars at night, passive-matrix OLEDs, PWM-modulated keypad or button illumination.

Motion blur: Blurring of moving images due to a large temporal aperture.

Motion quality: Perceived display image quality for moving content

Motion artifacts: Reduction of display image quality for moving display content and/or relative motion of display/eyeballs. Common motion artifacts are blur, ghosting, shadowing, ringing (overshoot), flickering, color break-up, dynamic false contours, judder (edge flicker), tearing, juggedness, and jitter.

Motion up-sampling: Increase of rendering rate by frame interpolation. Decreases the temporal aperture while keeping the frame duty and hence the display luminance and luminous efficacy (common in TVs).

Rendering rate: The speed at which the GPU delivers frames to the frame buffer and display, also called sampling rate in the case of camera; unit: frames per second (fps).

Refresh rate: The speed at which the display updates its content from frame memory. This is always equal to or larger than the rendering rate; unit: Hz.

Refresh up-sampling: Increase of refresh rate by frame duplication in order to avoid flicker. Well-known example is motion pictures which are sampled at 24 fps. Each frame is displayed three times so the refresh rate becomes 24×3=72 Hz. If the refresh rate is a non-integer multiple of the sampling rate, than frame drop and/or tearing may occur.

Ringing: Exaggeration of pixel levels at a pixel level transition, caused by excessive over drive in LCDs and/or spatial high-pass filtering. With proper amount of ringing, the image looks sharper.

Sampling time: Time during which motion is captured and temporally integrated similar to shutter time in cameras. In graphics rendering, sampling time is zero.

Shader (fragment shader): Translation between continuous vector graphics representation and quantized (sampled) rasterized image. Separates image into primary colors (color fields/planes).

Tearing: Spatio-temporal interference between rendering and refresh. This occurs when a frame starts to be written to the display before the previous frame has been refreshed completely. Tearing can be avoided by synchronization of the refresh and frame write signal, such as TE-signal.

Temporal aperture: Shortest optical/electrical shutter time in the imaging chain (camera-graphics-display). Synthetic graphics rendering does not have any shutter time so the temporal aperture for moving graphics is determined by the display's hold time. For camera or video content, the temporal aperture also depends on the shutter time and sampling rate of the camera. The shorter the temporal aperture, the crisper the moving image.

YCC color space: YCbCr, Y′CbCr, or Y Pb/Cb Pr/Cr, also written as YC_{B}C_{R} or Y′C_{B}C_{R}, is a family of color spaces used as a part of the color image pipeline in video and digital photography systems. Y′ is the lama component and C_{B} and C_{R} are the blue-difference and red-difference chroma components. Y′ (with prime) is distinguished from Y which is luminance, meaning that light intensity is non-linearly encoded using gamma correction.

The following abbreviations that may be found in the specification and/or the drawing figures are defined as follows:
BFI black frame insertion
Bpp bits per pixel (unit of addressable color depth; much bigger than the actual color depth; to render all colors in sRGB, for example, only 18 bpp is needed, not 24 bpp)
CCD coupled-charged device
CMOS complimentary metal-oxide-semiconductor
CHU color break-up
CMY cyan, magenta, yellow (primary colors for printing, brighter than RGB).
CCT correlated color temperature (describes the color of white; corresponds to a black body with the temperature measured in Kelvin (K). Centre of CCT interval has a spectral power distribution that follows Planck's radiation law)
DMA direct memory access
DMD digital mirror device
DMS digital micro shutter (DMS is a trademark of Qualcomm/Pixtronix
DSI display serial interface
FFF flicker fusion frequency
Fps frames per second (unit of rendering speed)
FSC field sequential color (color by temporal instead of spatial fusion)
GPU graphics processing unit (renders synthesized as well as captured content)
HWA hardware accelerator (makes scrolling, zooming, rotation, panning smoother)
Hz Hertz
IC integrated circuit
ISP image signal processor
JPEG joint photographic experts group
LBU light break-up LCD liquid crystal display
LED light-emitting diode (used in LCD backlights)
LUT look-up table
MPEG moving picture experts group
NED near-eye display
OLED organic LED
PWM pulse width modulation
RGB red, green, blue (common primary colors for electronic displays)
SPET smooth pursuit eye tracking (eye's smooth tracking of a moving natural object as opposed to the stepped motion of objects rendered on a display)
sRGB standardized color space with RGB primaries of certain chromaticities and a tone rendering curve based on a power function with the exponent (gamma) equal to 2.2; white point of sRGB is D65, i.e., white with a CCT of 6500 K
TE tearing effect
UT user interface

What is claimed is:

1. A method comprising:
rendering, by an operating module of an apparatus, each primary color of a plurality of primary colors in each frame of an image separately in a space-time domain; and
writing data indicative of the rendered image in a buffer memory by the operating module.

2. The method of claim 1, further comprising:
serializing or parallelizing written image data to a bus for displaying on a field sequential color display.

3. The method of claim 1, wherein the buffer memory is a frame buffer, an intermediate buffer integrated circuit, a buffer located in a display or a buffer located in an integrated circuit of the display, the display is for displaying the written image data.

4. The method of claim 1, wherein the primary colors are red green and blue.

5. The method of claim 1, further comprising:
moving a pointer of the written data indicative of the rendered image in the buffer memory by the operating module.

6. The method of claim 1, wherein the operating module comprises at least a graphic hardware accelerator configured to minimize at least blurring, and a displayed image of the rendered image from the buffer memory is provided a fast movement on a display by moving the pointer using the graphic hardware accelerator.

7. The method of claim 6, wherein the fast movement of the displayed image is scrolling, zooming, rotation, tilting or panning

8. The method of claim 1, wherein a field rate for displaying the rendered image data is equal to a frame rate multiplied by a number of the primary colors.

9. The method of claim 1, wherein the operating module comprises at least a graphic processing unit configured to operate on a single color plane at a sampling rate equal to a frame rendering rate multiplied by a number of the primary colors, and a fragment shader operating on the single color plane.

10. The method of claim 1, wherein the plurality of primary colors comprise three or more primary colors.

11. The method of claim 1, wherein the operating module comprises a color-sequential sampling solid-state camera configured to sample each primary color sequentially when capturing the image.

12. The method of claim 11, wherein the color-sequential sampling solid-state camera is a monochrome camera configured to sample colors sequentially using color-sequential illumination synchronized with the camera.

13. The method of claim 1, wherein the operating module comprises a video decoder, an up-sampling module and an image signal processor comprising a single color field filter.

14. The method of claim 1, wherein the operating module comprises a high sampling rate camera and an image signal processor comprising a single color field filter.

15. An apparatus comprising:
at least one processor and a memory storing a set of computer instructions, in which the processor and the memory storing the computer instructions are configured to cause the apparatus to:
render each primary color of a plurality of primary colors in each frame of an image separately in a space-time domain; and
write data indicative of the rendered image in a buffer memory by the operating module.

16. The apparatus of claim 15, wherein the computer instructions are configured to further cause the apparatus to:
serialize or parallelize written image data to a bus for displaying on a sequential color display.

17. The apparatus of claim 15, wherein a field rate for displaying the rendered image data is equal to a frame rate multiplied by a number of the primary colors.

18. The apparatus of claim 15, wherein the computer instructions are configured to further cause the apparatus to:
move a pointer of the written data indicative of the rendered image in the buffer memory.

19. The apparatus of claim 1, wherein the operating module comprises one or more of:
a graphic processing unit,
a graphic hardware accelerator,
a fragment shader operating on a single color plane,
a video decoder,
an up-sampling module,
an image signal processor comprising a single color field filter,
a high sampling rate camera, and
a color-sequential sampling solid-state camera capturing the image.

20. A computer program product comprising a non-transitory computer readable medium bearing computer program code embodied herein for use with a computer, the computer program code comprising:
code for rendering each primary color of a plurality of primary colors in each frame of an image separately in a space-time domain; and
code for writing data indicative of the rendered image in a buffer memory.
